(19) United States
(12) Patent Application Publication
(10) Pub. No.: US 2026/0213925 A1
(43) Pub. Date: Jul. 23, 2026

(54) RADIO COMMUNICATION SYSTEM, COMMUNICATION APPARATUS, RADIO COMMUNICATION TERMINAL, COMMUNICATION METHOD AND PROGRAM

(71) Applicant: NTT, Inc., Tokyo (JP)

(72) Inventors: Motoharu SASAKI, Tokyo (JP); Takeru FUKUSHIMA, Tokyo (JP); Takatsune MORIYAMA, Tokyo (JP)

(21) Appl. No.: 19/137,817

(22) PCT Filed: Dec. 13, 2022
(86) PCT No.: PCT/JP2022/045932

§ 371 Date: Jun. 11, 2025

(51) Int. Cl. H04L 9/08; H04L 9/00

(52) U.S. Cl. CPC H04L 9/0825; H04L 9/50

(57) ABSTRACT

A radio communication system includes one or more communication apparatuses that function as base stations for wireless communication. A communication apparatus of the one or more communication apparatuses includes an issuance unit configured to issue a transaction including information to a blockchain network by giving a signature of the communication apparatus to the information in response to receiving a request for contract conclusion of wireless communication from a radio communication terminal, the request including the information to which a signature of the radio communication terminal is given, and a provision unit configured to provide the wireless communication to the radio communication terminal in a case where the transaction is approved based on verification of the signatures in the blockchain network, thereby improving flexibility regarding use of a wireless line.

### TECHNICAL FIELD

The present invention relates to a radio communication system, a communication apparatus, a radio communication terminal, a communication method, and a program.

### BACKGROUND ART

Wireless communication traffic is increasing, and it is important to make various wireless communication systems (wireless NWs) including a private wireless communication system available in a cross-functional manner in order to secure wireless resources.

Conventionally, there is a method of using wireless NWs of a plurality of owners, such as a Wi-Fi (registered trademark) shared service or a service using a SIM server on a cloud.

CITATION LIST

### Non-Patent Literature

Non-Patent Literature 1: “fon”, [online], the Internet <https://fon.ne.jp/>
Non-Patent Literature 2: “Cloud SIM”, [online], the Internet <https://jp.ucloudlink.com/html/technology-cloudsim/>

### SUMMARY OF INVENTION

### Technical Problem

However, in the conventional art, there are problems such as high cost/low fault tolerance since it is not possible to use various wireless NWs having different owners and communication standards or a centralized control station for managing contract authentication of a plurality of wireless NWs is required.

In order to use the wireless NWs having different owners and communication standards in a cross-functional manner, it is necessary to achieve a common contract/authentication in various wireless NWs including private wireless in a secure and low cost manner.

The present invention has been made in view of the above points, and an object is to improve the flexibility regarding use of a wireless line.

### Solution to Problem

Therefore, in order to solve the above problem, a radio communication system including one or more communication apparatuses that function as base stations for wireless communication is provided. A communication apparatus of the one or more communication apparatuses includes an issuance unit configured to issue a transaction including information to a blockchain network by giving a signature of the communication apparatus to the information in response to receiving a request for contract conclusion of wireless communication from a radio communication terminal, the request including the information to which a signature of the radio communication terminal is given, and a provision unit configured to provide the wireless communication to the radio communication terminal in a case where the transaction is approved based on verification of the signatures in the blockchain network.

### Advantageous Effects of Invention

Flexibility regarding use of a wireless line can be improved.

### BRIEF DESCRIPTION OF DRAWINGS

FIG. 1 is a diagram illustrating a configuration example of a radio communication system according to a first embodiment.

FIG. 2 is a diagram illustrating a hardware configuration example of each node 11 constituting a blockchain NW 10 according to the first embodiment.

FIG. 3 is a diagram illustrating a functional configuration example of the node 11 of the blockchain NW 10 according to the first embodiment.

FIG. 4 is a diagram illustrating a functional configuration example of a BS 20 according to the first embodiment.

FIG. 5 is a diagram illustrating a functional configuration example of a UE 30 according to the first embodiment.

FIG. 6 is a diagram for describing an example of a processing procedure executed in the radio communication system according to the first embodiment.

FIG. 7 is a diagram for describing an environment achieved by the first embodiment.

FIG. 8 is a diagram illustrating a functional configuration example of a node 11 of a blockchain NW 10 according to a second embodiment.

FIG. 9 is a diagram for describing an example of a processing procedure executed in a radio communication system according to the second embodiment.

FIG. 10 is a diagram for describing an example of a processing procedure executed in the case of connection to another line according to the second embodiment.

FIG. 11 is a diagram illustrating a functional configuration example of a BS 20 according to a third embodiment.

FIG. 12 is a diagram illustrating a functional configuration example of a UE 30 according to the third embodiment.

FIG. 13 is a diagram for describing an example of a processing procedure executed in a radio communication system according to the third embodiment.

FIG. 14 is a diagram for describing an example of a processing procedure executed in the case of connection to another line according to the third embodiment.

FIG. 15 is a diagram illustrating a configuration example of a radio communication system according to a fourth embodiment.

FIG. 16 is a diagram illustrating a functional configuration example of a node 11 of a blockchain NW 10 according to the fourth embodiment.

FIG. 17 is a diagram illustrating a functional configuration example of a UE 40 according to the fourth embodiment.

FIG. 18 is a diagram for describing an example of a processing procedure executed in a radio communication system according to the fourth embodiment.

### DESCRIPTION OF EMBODIMENTS

In a first embodiment, a radio base station (BS 20) such as a Wi-Fi base station or a cellular base station of various network providers (hereinafter, referred to as “NW providers”) issues a transaction related to a communication contract with an end terminal (UE 30) used by a user to a blockchain network, and contract/authentication is executed using the blockchain network. Note that the contract refers to an agreement that enables communication under conditions such as communication quality/price/period concluded between the BS 20 and the UE 30. Authentication refers to verifying a transaction related to a contract.

The identity confirmation of the UE 30 requesting the communication contract and the identity confirmation of the BS 20 issuing the transaction are achieved by collating information registered in advance on the blockchain network (verifying each signature with a public key of each of the UE 30 and the BS 20 registered in advance) using respective digital signatures (hereinafter, simply referred to as “signatures”).

After verifying that there is no falsification or the like in the transaction on the blockchain network, the contract/authentication is performed according to various consensus building algorithms such as PoW and PoA.

Hereinafter, the first embodiment will be described with reference to the drawings. In the present embodiment, a technology for enabling connection to a radio base station to which an end terminal is not contracted in advance is disclosed. In the first embodiment, various NW providers execute contract/authentication for a communication contract with an uncontracted end terminal by using a blockchain network.

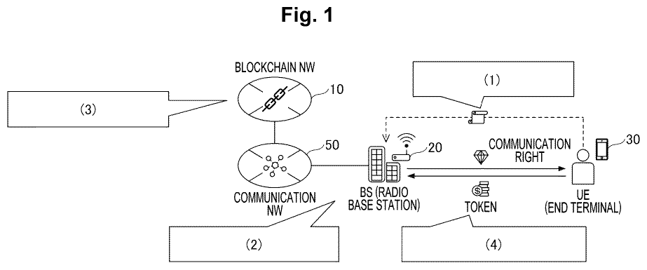

FIG. 1 is a diagram illustrating a configuration example of a radio communication system according to the first embodiment. In FIG. 1, the radio communication system includes one or more UEs 30, one or more BSs 20, one or more communication NWs 50, a blockchain NW 10, and the like.

The UE 30 is a terminal used by a user, such as a smartphone, a tablet terminal, or a personal computer (PC). In the case of connection to an uncontracted BS 20, the UE 30 requests the communication contract to the BS 20. When there is a plurality of corresponding BSs 20, the UE 30 requests the communication contract to the BS 20 that is most suitable for its own contract condition from the contract conditions of the BSs 20. At the time of execution of the contract, a communication contract fee is paid from (the user of) the UE 30 to the network provider (hereinafter, referred to as “NW provider”) related to the BS 20. In addition to the payment to the NW provider, the communication contract fee may include a fee or the like for a node 11 that has performed authentication in the blockchain NW 10.

The BS 20 is an example of a communication apparatus that functions as a radio base station such as a Wi-Fi base station or a cellular base station. The BS 20 provides wireless communication to the UE 30 according to the communication contract. The NW provider related to the BS 20 receives the communication contract fee. Upon receiving a request for a communication contract from the UE 30, the BS 20 issues a transaction corresponding to the request onto the blockchain NW 10 via the communication NW 50. One NW provider may manage a plurality of BSs 20. There may be a plurality of NW providers.

The communication NW 50 is a communication network that connects each BS 20 and the blockchain NW 10. The communication NW 50 may include a wired section or a wireless section.

The blockchain NW 10 is a blockchain network including a plurality of nodes 11 that records transactions in a ledger in a blockchain format. The blockchain NW 10 authenticates the transaction by verifying the signatures of the BS 20 and the UE 30 given to the transaction, and adds a new block to the ledger. The block to be added is decided by various consensus building algorithms such as PoW and PoA.

A communication procedure in the first embodiment illustrated in (1) to (4) of FIG. 1 is as described below.
(1) The UE 30 transmits, to the BS 20, a request for a communication contract to which its own signature is given.
(2) The BS 20 adds its own signature and issues a transaction onto the blockchain NW 10.
(3) The blockchain NW 10 verifies the signatures of the BS 20 and the UE 30, authenticates the transaction, and notifies the BS 20 of the authentication result.
(4) The BS 20 and the UE 30 execute the communication contract according to the transaction.

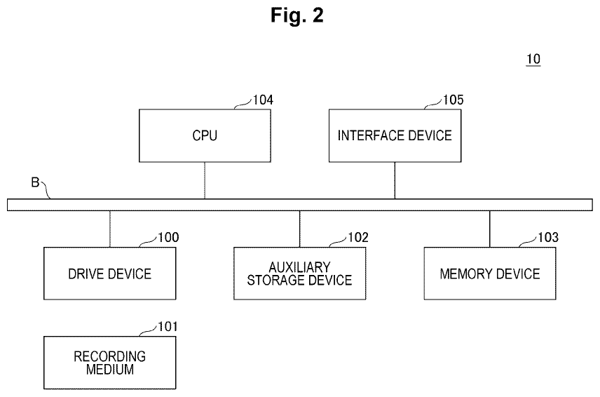

FIG. 2 is a diagram illustrating a hardware configuration example of each node 11 constituting the blockchain NW 10 according to the first embodiment. Each node 11 includes a drive device 100, an auxiliary storage device 102, a memory device 103, a CPU 104, an interface device 105, and the like which are connected to each other by a bus B.

A program for implementing processing in each node 11 is provided by a recording medium 101 such as a CD-ROM. When the recording medium 101 storing the program is set in the drive device 100, the program is installed from the recording medium 101 to the auxiliary storage device 102 via the drive device 100. However, the program is not necessarily installed from the recording medium 101 and may be downloaded from another computer via a network. The auxiliary storage device 102 stores the installed program and also stores necessary files, data, and the like.

When an instruction to start the program is given, the memory device 103 reads the program from the auxiliary storage device 102 and stores the program. The CPU 104 executes a function related to each node 11 according to the program stored in the memory device 103. The interface device 105 is used as an interface for connection to the network.

Note that the UE 30, the BS 20, and the like may also have a hardware configuration as illustrated in FIG. 2.

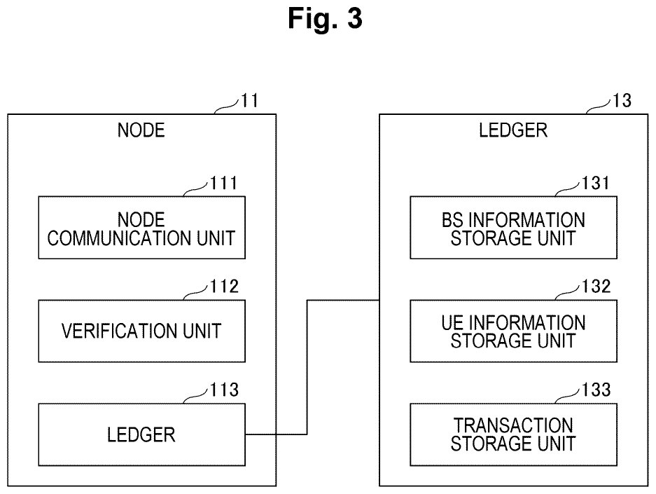

FIG. 3 is a diagram illustrating a functional configuration example of the node 11 of the blockchain NW 10 according to the first embodiment. In FIG. 3, the node 11 includes a node communication unit 111, a verification unit 112, a ledger 113, and the like. The node communication unit 111 and the verification unit 112 are implemented by one or more programs installed on the node 11 causing the CPU 104 to execute processing. The ledger 113 can be implemented by using, for example, the auxiliary storage device 102 or a storage device connectable to the node 11 via a network.

The node communication unit 111 exchanges blockchain information and transaction information with another node 11 or each BS 20.

The verification unit 112 approves a new transaction issued to the blockchain NW 10, verifies a new block obtained by collecting approved transactions, and the like.

The ledger 113 is a storage unit that records a blockchain or the like. The ledger 113 includes a BS information storage unit 131, a UE information storage unit 132, a transaction storage unit 133, and the like.

The BS information storage unit 131 stores various types of information regarding the BS 20 that can execute the communication contract using the blockchain NW 10. The various types of information include a public key of the BS 20.

The UE information storage unit 132 stores various types of information regarding the UE 30 that can execute the communication contract using the blockchain. The various types of information include a public key of the UE 30.

The transaction storage unit 133 stores a transaction.

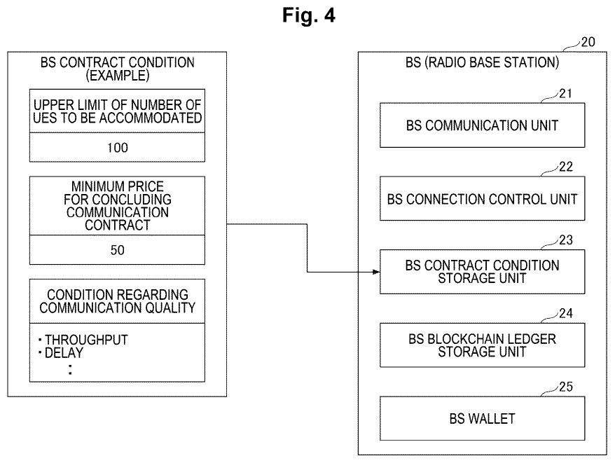

FIG. 4 is a diagram illustrating a functional configuration example of the BS 20 according to the first embodiment. In FIG. 4, the BS 20 includes a BS communication unit 21 and a BS connection control unit 22. Each of these units is implemented by processing executed by the CPU of the BS 20 by one or more programs installed in the BS 20. The BS 20 also uses storage units such as a BS contract condition storage unit 23, a BS blockchain ledger storage unit 24, and a BS wallet 25. Each of these storage units can be implemented by using, for example, the auxiliary storage device of the BS 20 or a storage device connectable to the BS 20 via a network.

The BS communication unit 21 receives a request for a communication contract from a temporarily connected UE 30 and issues a transaction related to the communication contract onto the blockchain NW 10. The temporary connection refers to connection of wireless communication permitted for a request for a communication contract.

The BS connection control unit 22 specifies the UE 30 as a wireless communication provision destination on the basis of the communication contract related to the transaction approved on the blockchain NW 10, and provides the wireless communication to the UE 30.

The BS contract condition storage unit 23 stores the contract condition on the BS 20 side (hereinafter referred to as “BS contract condition”) in advance. The BS contract condition includes, for example, an upper limit of the number of UEs to be accommodated, a minimum price for concluding a communication contract, a condition regarding communication quality (for example, “throughput of ○○ Mbps or more”, “maximum throughput of ○○ Mbps”, “delay time of ○○ seconds”, and the like), and the like. The BS contract condition is used to determine the BS 20 as a connection destination of the UE 30. Note that conditions regarding the minimum price and the communication quality may be fixed, but may be dynamically calculated from a time zone, the number of UEs to be accommodated, or the like according to a predetermined algorithm.

The BS blockchain ledger storage unit 24 stores transactions and the like approved on the blockchain NW 10.

The BS wallet 25 manages a secret key of the account of the BS 20. By using the BS wallet 25, the balance of the account can be confirmed, and the token can be taken in and out.

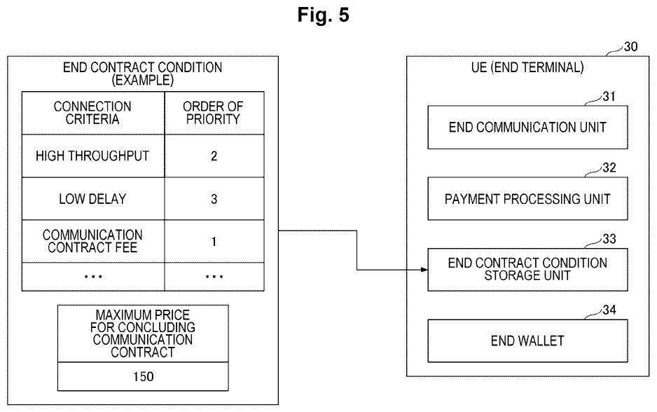

FIG. 5 is a diagram illustrating a functional configuration example of the UE 30 according to the first embodiment. In FIG. 5, the UE 30 includes an end communication unit 31 and a payment processing unit 32.

Each of these units is implemented by processing executed by the CPU of the UE 30 by one or more programs installed in the UE 30. The UE 30 also uses storage units such as an end contract condition storage unit 33 and an end wallet 34. Each of these storage units can be implemented by using, for example, the auxiliary storage device of the UE 30 or a storage device connectable to the UE 30 via a network.

The end contract condition storage unit 33 stores in advance one or more connection criteria that are criteria for determining which BS 20 is preferentially connected, the order of priority of the connection criteria, and the contract condition on the UE 30 side (hereinafter referred to as “end contract condition”) such as the maximum price for concluding a communication contract.

The end communication unit 31 selects the BS 20 as a connection destination on the basis of the end contract condition and the BS contract condition, and sends a request for a communication contract to the BS 20.

After the conclusion of the communication contract, the payment processing unit 32 executes processing related to the payment of consideration of the token transferred from the UE 30 to the BS 20 as the fee for the wireless communication provided from the BS 20. Any method such as transfer of cryptocurrency, credit card payment, or bank transfer can be used as consideration of the token.

The end wallet 34 manages a secret key of the account of the UE 30, the balance of (the user of) the UE 30, and the like. By using the wallet, the balance of the account can be confirmed, and the token can be taken in and out.

Hereinafter, a processing procedure executed in the radio communication system according to the first embodiment will be described.

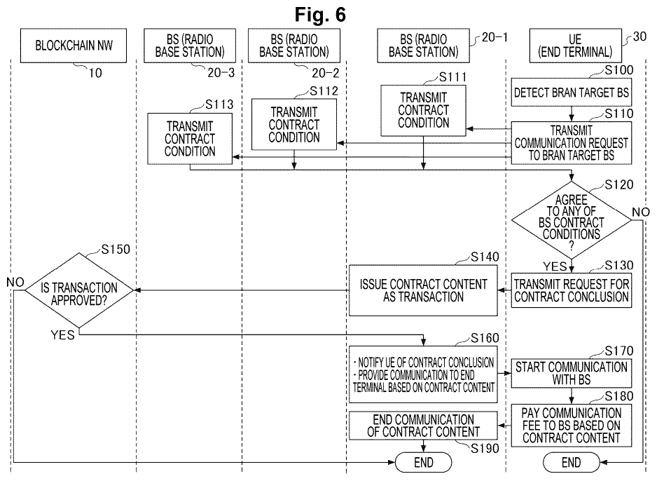

FIG. 6 is a diagram for describing an example of a processing procedure executed in the radio communication system according to the first embodiment.

In step S100, the end communication unit 31 of the UE 30 detects a BRAN target BS. The BRAN target BS refers to a BS capable of supporting sharing of a radio access using the blockchain NW 10, and refers to, in the first embodiment, the BS 20 having the functional configuration illustrated in FIG. 4. For example, the end communication unit 31 can detect the BS 20 by receiving a beacon or the like transmitted by the BS 20. In addition, the end communication unit 31 can determine whether or not the BS 20 is a BRAN target BS on the basis of the SSID, the MAC address, or the like of the BS 20 included in the beacon, for example. For example, the SSID, the MAC address, and the like of the BRAN target BS are registered in the blockchain NW 10 in advance, and the end communication unit 31 of the UE 30 acquires the list in advance. When the SSID and the MAC address included in the received beacon are included in the list, the end communication unit 31 detects the BRAN target BS based on the beacon.

Note that the BRAN means a blockchain radio access network (B-RAN). Here, it is assumed that three BSs 20: a BS 20-1, a BS 20-2, and a BS 20-3 are detected as BRAN target BSs.

Subsequently, the end communication unit 31 transmits a communication request to each detected BS 20 (S110), and upon receiving the communication request, the BS communication unit 21 of each BS 20 (BS 20-1, BS 20-2, and BS 20-3) that has received the communication request transmits the BS contract condition stored in the BS contract condition storage unit 23 of the BS 20 to the UE 30 that is the transmission source of the communication request (S111 to S113).

Upon receiving the BS contract condition from each BS 20, the end communication unit 31 of the UE 30 collates each BS contract condition with the end contract condition stored in the end contract condition storage unit 33 of the UE 30, and determines the presence or absence of an agreeable (allowable) BS contract condition (S120). This corresponds to determining whether or not to transmit a request in step S130 for each BS 20 related to each BS contract condition. For example, if the “upper limit of the number of UEs to be accommodated” of the BS contract condition (FIG. 4) exceeds the current number of accommodated UEs, and the “minimum price for concluding a communication contract” is equal to or lower than the “maximum price for concluding a communication contract” of the end contract condition (FIG. 5), it may be determined that the BS contract condition is agreeable.

If it is not possible to agree to any of the BS contract conditions (none of the BS contract conditions are allowable) (NO in S120), the processing procedure of FIG. 6 ends.

If any one or more of the BS contract conditions is agreeable (any one of the BS contract conditions is allowable) (YES in S120), the end communication unit 31 selects one BS contract condition from the BS contract conditions. The selection criteria at this time are in accordance with the connection criteria of the end contract condition (FIG. 5). If the connection criteria are as illustrated in FIG. 5, the BS contract condition in which the “minimum price for concluding a communication contract” is the lowest is selected. In a case of a plurality of BS contract conditions being selected as a result, the BS contract condition with the highest throughput is selected. In a case of a plurality of BS contract conditions being selected as a result, the BS contract condition with the smallest delay is selected. In this way, when the conditions are narrowed down to one BS contract condition, the end communication unit 31 temporarily connects to the BS 20 related to the BS contract condition, and transmits a request for contract conclusion to the BS 20 (S130). Note that the end communication unit 31 may cause the UE 30 to display a screen including the BS contract condition before transmitting the request for contract conclusion. In this case, the end communication unit 31 may transmit the request for contract conclusion to the BS 20 related to the BS contract condition only when the operation to agree to the contract conclusion based on the BS contract condition is performed by the user. Alternatively, the end communication unit 31 may cause the UE 30 to display a screen including all the BS contract conditions received in steps S111 to S113. In this case, the end communication unit 31 may transmit the request for contract conclusion to the BS 20 related to the BS contract condition when any of the BS contract conditions is selected by the user and the operation to agree to the contract conclusion based on the BS contract condition is performed by the user. In this case, step S120 need not be executed.

The request includes the contract content to which the signature of the UE 30 is given by the end communication unit 31 using the secret key stored in the end wallet 34 of the UE 30. The contract content includes, for example, a price, a condition regarding communication quality (“throughput of ○○ or more”, “maximum throughput of ○○”, “delay of ○ seconds”, and the like), a communicable time (contract period), and the like. It is sufficient if the contract content is derived so as to satisfy both contract conditions by a predetermined algorithm using the BS contract condition of the BS 20 as a connection destination and the end connection contract condition as inputs. In addition, the request includes information regarding the movement of the token as consideration of the price (hereinafter, referred to as “token transaction information”) (minus 100 tokens from the UE 30, plus 100 tokens to the BS 20-1, and the like). In the blockchain NW 10, a held token of each account is recorded on the basis of such token transaction information. Note that the token can be issued from within the range of the balance stored in the end wallet 34.

Note that an example is described in which a request for contract conclusion (that is, the contract content) is transmitted to the BS 20-1.

Upon receiving the request for contract conclusion, the BS communication unit 21 of the BS 20-1 gives the signature of the BS 20 to the contract content included in the request by using the secret key stored in the BS wallet 25, and issues a transaction including the contract content and the token transaction information to the blockchain NW 10 (S140). Note that the BS communication unit 21 of the BS 20-1 may execute step S140 only when the contract content satisfies the BS contract condition of the BS 20-1.

Subsequently, the blockchain NW 10 determines whether or not the transaction is approved (authentication of contract) (S150). Whether or not the transaction is approved is determined by the verification unit 112 of the node 11 according to a consensus building algorithm such as POW or PoA. The verification unit 112 of the node 11 verifies the signatures of the UE 30 and the BS 20-1 given to the contract content included in the transaction to perform identity confirmation. For verification of the signatures, the public key of the UE 30 and the public key of the BS 20-1 stored in the UE information storage unit 132 or the BS information storage unit 131 (FIG. 3) are used. The verification unit 112 may further confirm the presence or absence of the payment ability with respect to (the user of) the UE 30 on the basis of the token transaction information included in the transaction. The confirmation of the presence or absence of the payment ability may be performed, for example, on the basis of whether there is a balance equal to or larger than the price of the contract content with respect to (the user of) the UE 30, or may be performed using another known method. If the identity cannot be confirmed, there is a possibility of falsification, and if the payment ability does not exist, there is a possibility of an invalid contract. In such a case, the verification unit 112 determines that the transaction cannot be approved. Otherwise, the verification unit 112 determines that the transaction can be approved. As a result, the contract is authenticated. Upon the authentication of the agreement, the contract is concluded.

If the transaction is not approved (NO in S150), the processing procedure of FIG. 6 ends. If the transaction is approved (YES in S150), the transaction is spread to each node 11 of the blockchain NW 10, and the approved transaction is stored in the transaction storage unit 133 of each node 11. The transaction is also spread to the BS 20-1, which is one of the nodes 11 of the blockchain NW 10 at this time. The BS communication unit 21 of the BS 20-1 stores the transaction in the BS blockchain ledger storage unit 24.

Subsequently, the BS connection control unit 22 of the BS 20-1 acquires the transaction from the BS blockchain ledger storage unit 24, and specifies the UE 30 as a wireless communication provision destination on the basis of the contract content included in the transaction. The BS connection control unit 22 transmits a notification indicating the contract conclusion to the UE 30 and starts providing a wireless communication service to the UE 30 based on the contract content (S160). As a result, the end communication unit 31 of the UE 30 starts wireless communication using the BS 20-1 (S170).

Subsequently, the payment processing unit 32 of the UE 30 executes processing of paying a consideration of the token as a consideration (communication fee) of the wireless communication provided from the BS 20-1 (S180).

As a result, the communication fee is substantially paid from the UE 30 to the BS 20-1.

Thereafter, when the contract period included in the contract content expires, the BS connection control unit 22 of the BS 20-1 ends the wireless communication service based on the contract content (S190).

Note that the communication fee may be paid to the BS 20 at any timing of the start of communication or the end of communication.

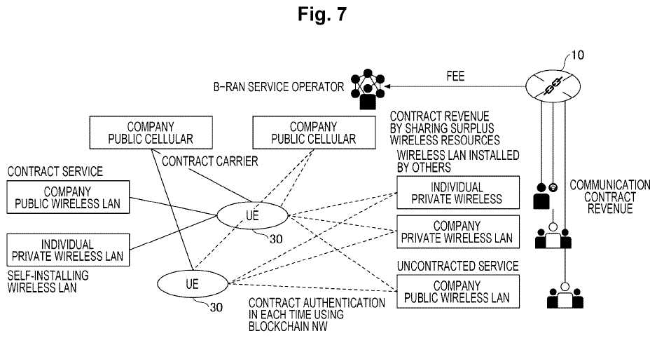

As described above, according to the first embodiment, flexibility regarding use of a wireless line can be improved. Specifically, by contract/authentication using the blockchain NW 10, it is possible to perform common contract/authentication that can use wireless NWs having different owners and communication standards in a cross-functional manner. As a result, as illustrated in FIG. 7, the user of the UE 30 can automatically detect a line with high communication quality flexibly outside regardless of whether or not the line is contracted and use the wireless communication at low cost. In addition, a B-RAN service operator can utilize the B-RAN as a contract authentication platform, provide services at low cost and securely, and obtain, for example, a service registration fee or a contract fee. A cellular line provider or a provider of a wireless LAN (Wi-Fi (registered trademark) or the like) can obtain contract fee revenue using wireless resources such as a time zone in which use is small.

In addition, by using the signatures, identity confirmation of the BS 20 and the UE 30 is secured, and information on the blockchain NW 10 has tamper resistance, so that a secure contract/authentication base can be achieved.

In addition, since the blockchain NW 10 is constructed in a distributed manner, a centralized control station is unnecessary, and cost reduction and high fault tolerance can be expected.

In addition, since an incentive is generated to widely provide the NW to the BS 20 that provides the NW because of the contract fee revenue related to the communication contract, it can be expected that the wireless resources are widely improved including the area where the wireless communication quality is poor.

Note that, in the above description, regarding the UE 30, only the communication with the BS 20 to be contracted using the blockchain NW 10 is described, but the UE 30 may be always connected to another line. In that case, communication with the BS 20 through a contract in the blockchain may operate as offload of another line.

Another line may be a line for which a contract not using a blockchain is made or a line for which a contract is separately made through a blockchain.

Next, a second embodiment will be described. In the second embodiment, points different from the first embodiment will be described. Points not specifically mentioned in the second embodiment may be the same as those in the first embodiment.

In the first embodiment, the example has been described in which the UE 30 selects the BS 20 as the connection destination (communication contract partner) of the UE 30 when the plurality of BSs 20 is present in the observation range of the UE 30. In the second embodiment, an example will be described in which the blockchain NW 10 determines the BS 20 as the connection destination of the UE 30 on the basis of the end contract condition and each BS contract condition.

The configuration of the radio communication system according to the second embodiment is as illustrated in FIG. 1, but the communication procedures of (1) to (4) in FIG. 1 in the second embodiment are as described below.
(1) The UE 30 transmits, to the BS 20, a request for a communication contract to which its own signature is given. At this time, the UE 30 sends a list of the BSs 20 for which radio signals have been observed.
(2) The BS 20 adds its own signature and issues a transaction including the list of the BSs 20 onto the blockchain.
(3) The blockchain NW 10 verifies the signatures of the BS 20 and the UE 30, authenticates the transaction, and notifies the BS 20 of the authentication result. In a case where the transaction is authenticated, the blockchain NW 10 determines an appropriate (suitable for the contract condition or the like) BS 20 from the list of the BSs 20 included in the transaction as the connection destination by the smart contract.
(4) The BS 20 and the UE 30 execute the communication contract according to the transaction.

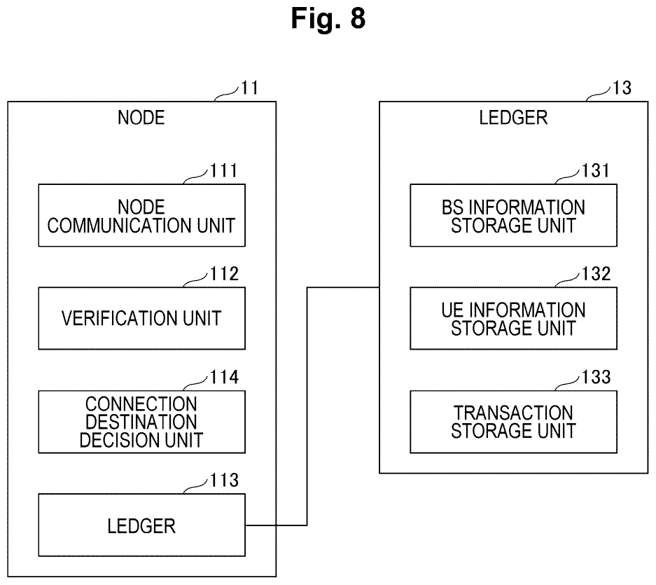

FIG. 8 is a diagram illustrating a functional configuration example of the node 11 of the blockchain NW 10 according to the second embodiment. In FIG. 8, the same parts as those in FIG. 3 are denoted by the same reference numerals, and the description thereof will be omitted as appropriate.

In FIG. 8, the node 11 further includes a connection destination decision unit 114. The connection destination decision unit 114 is achieved by processing in which a program installed as a smart contract with respect to the node 11 is executed by the CPU of the node 11.

The connection destination decision unit 114 extracts a list of the BSs 20 detected by the UE 30 from the transaction issued by the UE 30 and spread by the BS 20, and determines an appropriate communication contract partner on the basis of the contract conditions of the UE 30 and the BS 20. By adding information such as the number of UEs to be accommodated and hardware specs to the BS contract condition, the communication contract partner may be determined in consideration of the congestion degree and the communication quality. In addition, in a case where the congestion degree or the communication quality fluctuates over time, a prediction value after a certain period of time may be used for determination.

The functional configuration example of the BS 20 in the second embodiment may be similar to that in FIG. 4.

However, the functions of the BS communication unit 21 are partially different. Specifically, the BS communication unit 21 further registers the BS contract condition on the blockchain NW 10 in advance. The BS contract condition is stored in the BS information storage unit 131 of the ledger 113 of each node 11 of the blockchain NW 10.

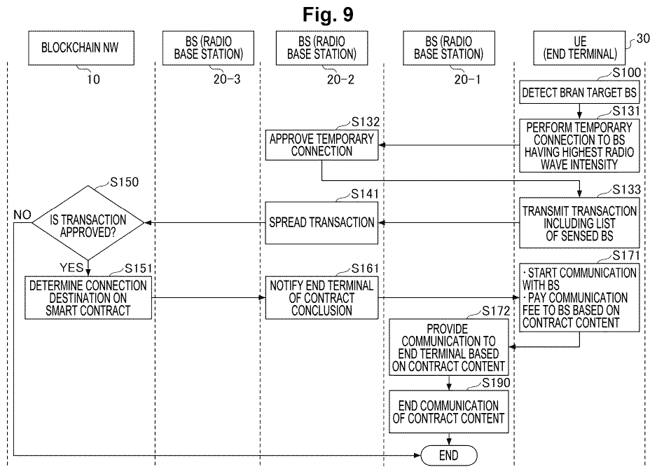

FIG. 9 is a diagram for describing an example of a processing procedure executed in the radio communication system according to the second embodiment. In FIG. 9, steps that are the same as those in FIG. 6 are denoted by the same step numbers, and the description thereof will be omitted as appropriate.

Subsequent to step S100, the end communication unit 31 requests temporary connection to the BS 20 having the highest radio wave intensity among the detected BSs 20 (S131). FIG. 9 illustrates an example in which the BS 20-2 is the BS 20 having the highest radio wave intensity.

Upon receiving the request for temporary connection, the BS communication unit 21 of the BS 20-2 transmits a response indicating approval of the temporary connection to the UE 30 (S132).

In response to the response, the end communication unit 31 of the UE 30 transmits, to the BS 20-2, a transaction including a list of detected BSs 20 (for example, a list of SSIDs) and the end contract condition and to which the signature of the UE 30 is given (S133).

Note that the end communication unit 31 gives the signature of the UE 30 to the transaction.

The BS communication unit 21 of the BS 20-2 gives the signature of the BS 20-2 to the transaction and spreads the transaction to the blockchain NW 10 (S141).

If the transaction is approved in the blockchain NW 10 (YES in S150), the connection destination decision unit 114 of any node 11 of the blockchain NW 10 extracts the list of the BSs 20 detected by the UE 30 from the transaction, and determines the BS 20 to be the connection destination of the UE 30 and the contract content on the basis of the end contract condition of the UE 30 included in the transaction and the BS contract condition of each BS 20 related to the list (S151). The connection destination and the contract content may be determined on the basis of a method similar to the decision performed by the UE 30 in the first embodiment, or may be performed on the basis of a decision algorithm using other information or the like registered on the blockchain NW 10. The determined connection destination and contract content are included in the transaction, and the transaction is spread to each node 11 of the blockchain NW 10 and each BS 20. Note that the BS contract condition of each BS 20 is stored in the BS information storage unit 131. In addition, the end contract condition of each UE 30 may also be stored in the UE information storage unit 132. In this case, in step S133, the end contract condition need not be included in the transaction.

The BS connection control unit 22 of the BS 20-2 specifies the UE 30 as the wireless communication provision destination on the basis of the contract content included in the transaction, and transmits a notification indicating the contract conclusion to the UE 30 (S161). Here, it is assumed that the BS 20-1 is determined as a target BS 20.

Subsequently, the end communication unit 31 of the UE 30 starts communication with the BS 20-1 indicated as the connection destination in the contract content, and the payment processing unit 32 of the UE 30 executes processing of paying a consideration of the token as a consideration (communication fee) of the wireless communication provided from the BS 20-1 (S171).

Subsequently, the BS connection control unit 22 of the BS 20-1 starts providing the wireless communication service to the UE 30 based on the contract content (S172).

Note that the communication fee may be paid to the BS 20 at any timing of the start of communication or the end of communication.

As described above, according to the second embodiment, effects similar to those of the first embodiment can be obtained. Further, according to the second embodiment, it is possible to automatically select an appropriate connection destination from the plurality of BSs 20 by using the smart contract.

Note that, in the above description, regarding the UE 30, only the communication with the BS 20 to be contracted using the blockchain is described, but the UE 30 may be always connected to another line. Another line may be a line for which a contract not using the blockchain NW 10 is made or a line for which a contract is separately made through the blockchain NW 10. A processing procedure in this case will be described.

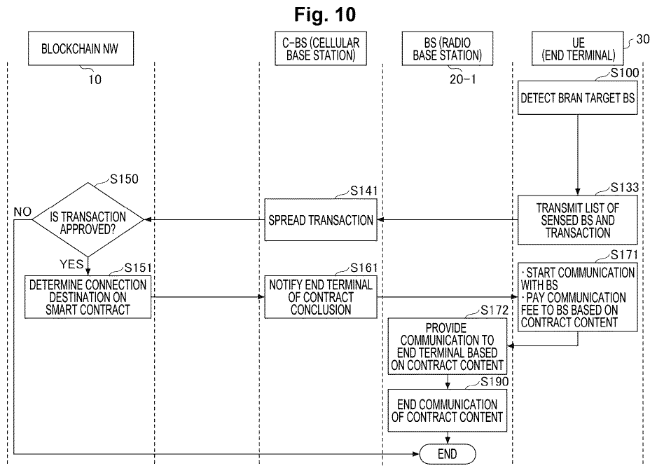

FIG. 10 is a diagram for describing an example of a processing procedure executed in the case of connection to another line according to the second embodiment. In FIG. 10, steps that are the same as or correspond to those in FIG. 9 are denoted by the same step numbers, and the description thereof will be omitted as appropriate. In FIG. 10, a C-BS 20 may be a base station such as a cellular line provided by a carrier, public Wi-Fi (registered trademark), or Wi-Fi (registered trademark) installed by an individual, which is not under contract using the blockchain NW 10, or may be a BRAN target base station different from the BS 20-1 with which the UE 30 is already contracted and communicating using the blockchain NW 10.

In FIG. 10, it is assumed that the UE 30 is connected to the C-BS 20, which is a cellular base station. In this state, when sensing the BRAN target BS (S100), the end communication unit 31 of the UE 30 transmits, to the C-BS 20, a transaction including a list of the sensed BSs 20 (for example, a list of SSIDs) and to which the signature of the UE 30 is given (S133). Hereinafter, the C-BS 20 functions as a substitute for the BS 20-2 in FIG. 9. As a result, the UE 30 can receive the provision of the wireless communication from the BS 20-1.

Next, a third embodiment will be described. In the third embodiment, points different from the second embodiment will be described. Points that are not specifically described in the third embodiment may be similar to those in the second embodiment.

In the third embodiment, an appropriate communication contract partner is determined on the blockchain NW 10 on the basis of the position information of the UE 30 in order to enable the user of the UE 30 to contract the wireless NW and perform communication without being affected by a time lag of contract/authentication at the time of movement.

The configuration of the radio communication system according to the third embodiment is as illustrated in FIG. 1, but the communication procedures of (1) to (4) in FIG. 1 in the third embodiment are as described below.
(1) The UE 30 transmits, to the BS 20, a request for a communication contract including its own position information and to which its own signature is given.
(2) The BS 20 adds its own signature and issues a transaction onto the blockchain.
(3) The blockchain NW 10 verifies the signatures of the BS 20 and the UE 30, authenticates the transaction, and notifies the BS 20 of the authentication result. In a case where the transaction is authenticated, the blockchain NW 10 determines the BS 20 as the connection destination on the basis of the position information of the UE 30, the contract conditions of the BS 20 and the UE 30, and the like by the smart contract. The blockchain NW 10 may predict the future position of the UE 30 from the position information sent by the UE 30 and first execute a contract with the BS 20 existing in the area after the movement for a certain period of time.
(4) The BS 20 and the UE 30 execute the communication contract according to the transaction.

Note that, as the position information of the UE 30, the position information of the temporarily connected BS 20 or the position information estimated by the BS 20 by sensing or the like may be used in addition to that sent by the UE 30.

In the third embodiment, the functional configuration of each node 11 of the blockchain NW 10 may be as illustrated in FIG. 8. However, the BS information storage unit 131 further stores the position information of each BS 20 that performs the communication contract using the blockchain NW 10.

In addition, the connection destination decision unit 114 extracts the position information of the UE 30 from the transaction issued by the UE 30 and spread by the BS 20, and determines an appropriate communication contract partner on the basis of the position information of the UE 30 and the contract conditions of the UE 30 and the BS 20. The connection destination decision unit 114 may predict the future position of the UE 30 from the position information of the UE 30 and first execute a contract with the BS 20 existing in the area after the movement for a certain period of time.

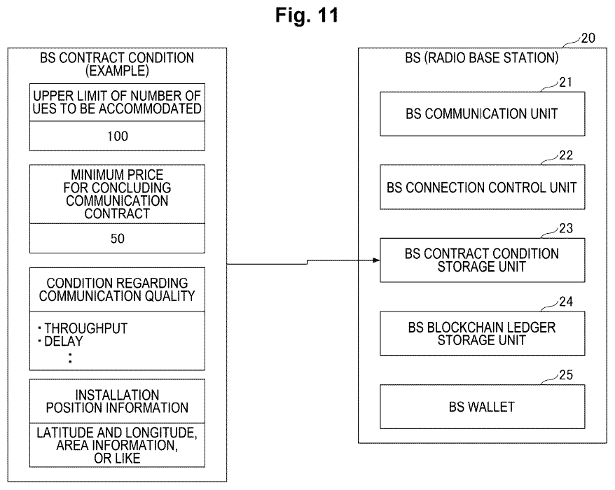

FIG. 11 is a diagram illustrating a functional configuration example of the BS 20 according to the third embodiment. In FIG. 11, the same or corresponding parts as those in FIG. 4 are denoted by the same reference numerals, and the description thereof will be omitted as appropriate.

As illustrated in FIG. 11, the BS contract condition further includes installation position information of the BS 20. The installation position information may be, for example, information indicating the latitude and longitude of the position where the BS 20 is installed, or identification information of an area where the BS 20 is installed (an area covered by the BS 20).

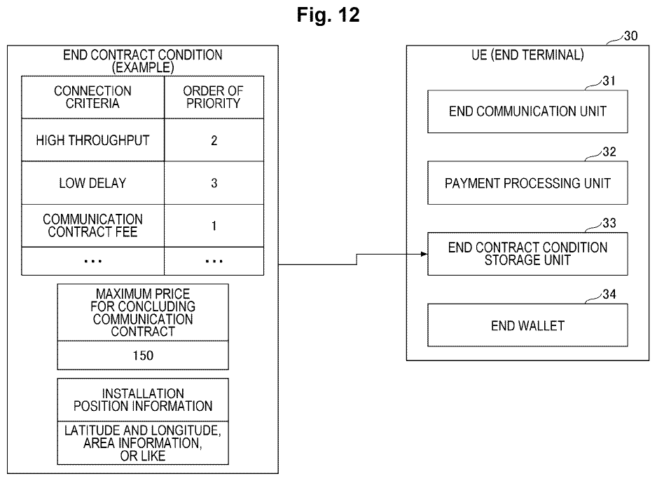

FIG. 12 is a diagram illustrating a functional configuration example of the UE 30 according to the third embodiment. In FIG. 12, the same or corresponding parts as those in FIG. 5 are denoted by the same reference numerals, and the description thereof will be omitted as appropriate.

As illustrated in FIG. 12, the end contract condition further includes the current position information of the UE 30. The position information may be, for example, information indicating the latitude and longitude of the current position of the UE 30, or identification information of an area in which the UE 30 is present (belongs) at the present time.

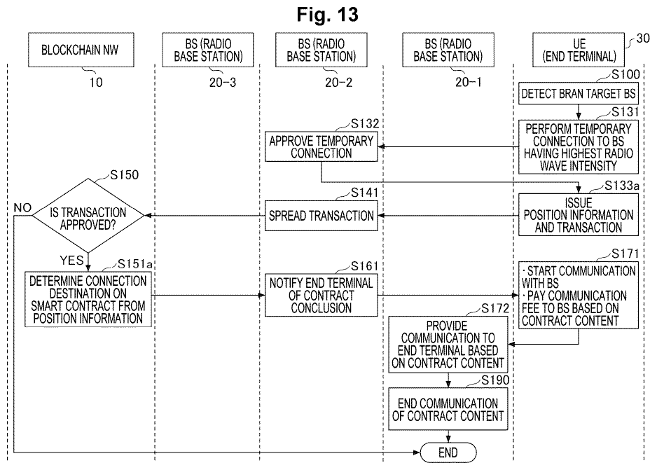

FIG. 13 is a diagram for describing an example of a processing procedure executed in the radio communication system according to the third embodiment. In FIG. 13, steps that are the same as those in FIG. 9 are denoted by the same step numbers, and the description thereof will be omitted as appropriate.

In FIG. 13, steps S133 and S151 in FIG. 9 are replaced with steps S133a and S151a.

In step S133a, in response to the reception of the response indicating the approval of the temporary connection, the end communication unit 31 of the UE 30 transmits, to the BS 20-2, a transaction including the end contract condition including the position information of the UE 30 and to which the signature of the UE 30 is given. Note that the transaction need not include the list of the BSs 20.

In step S151a, the connection destination decision unit 114 determines the BS 20 to be the connection destination of the UE 30 and the contract content on the basis of the position information and the end contract condition of the UE 30 included in the transaction and the contract condition of each BS 20 stored in the BS information storage unit 131. For example, the connection destination decision unit 114 extracts the BS 20 in a predetermined range (range in which the UE 30 can receive radio waves) from the position information of the UE 30 on the basis of the installation position information included in each BS contract condition. Alternatively, the connection destination decision unit 114 may predict the future position of the UE 30 from the position information of the UE 30 and extract the BS 20 installed in the area where the UE 30 is estimated to be located after the movement for a certain period of time. For the prediction of the future position of the UE 30, for example, linear prediction (in the case of movement from area A→area B→area C, for example, the direction of area D on the extension line of the movement trajectory) based on the history of the position information of the UE 30 may be used, or a method of predicting in which direction the UE will statistically move next from the history of the contract contents of all the UEs in the past (for example, 70% of the UEs 30 contracted with the BS 20-1 moved to the adjacent area E thereafter) may be adopted.

The connection destination decision unit 114 selects one BS contract condition by collating the BS contract condition of each extracted BS 20 with the end contract condition of the UE 30. A method of selecting one BS contract condition may be similar to that of the second embodiment. The determined connection destination and contract content are included in the transaction, and the transaction is spread to each node 11 of the blockchain NW 10 and each BS 20.

As described above, according to the third embodiment, effects similar to those of the first embodiment can be obtained. Further, according to the third embodiment, it is possible to automatically select an appropriate connection destination according to the position information and the contract condition by using the smart contract.

Note that, in the above description, regarding the UE 30, only the communication with the BS 20 to be contracted using the blockchain is described, but the UE 30 may be always connected to another line as in the first embodiment. A processing procedure in this case will be

### Described.

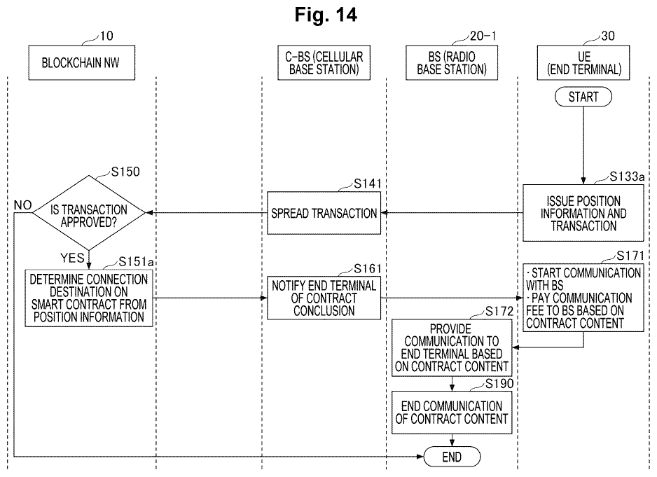

FIG. 14 is a diagram for describing an example of a processing procedure executed in the case of connection to another line according to the third embodiment. In FIG. 14, steps that are the same as those in FIG. 10 or 13 are denoted by the same step numbers, and the description thereof will be omitted as appropriate.

In comparison with FIG. 10, step S100 need not be executed in FIG. 14. After step S133 in FIG. 10, S133 and S151 are replaced with S133a and S151a described in FIG. 13.

Next, a fourth embodiment will be described. In the fourth embodiment, points different from the first embodiment will be described. Points that are not specifically described in the fourth embodiment may be similar to those in the first embodiment.

Due to the high frequency band, the wireless area is narrowed, and there is a risk that an end terminal that cannot be connected to the wireless NW may appear. There is device-to-device communication (D2D) as a method of easily extending the wireless area in such a situation.

In the fourth embodiment, device-to-device communication is applied to the first embodiment.

Specifically, a UE 40 (relay terminal) different from the UE 30 as the end terminal to perform wireless communication is an example of a communication apparatus that functions as a radio base station in the fourth embodiment. That is, for a D2D communication contract between various terminals, contract/authentication is executed using the blockchain NW 10.

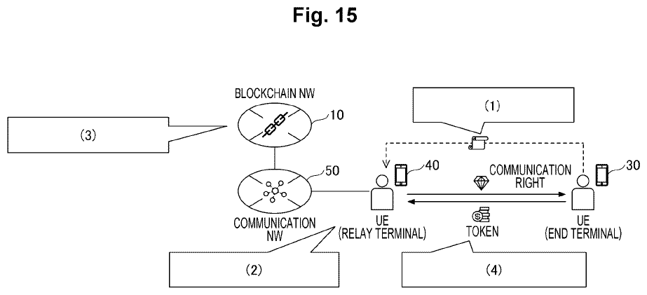

FIG. 15 is a diagram illustrating a configuration example of a radio communication system according to the fourth embodiment. In FIG. 15, the same parts as those in FIG. 1 are denoted by the same reference numerals, and the description thereof will be omitted as appropriate.

In FIG. 15, the BS 20 in FIG. 1 is replaced with the UE 40 as a relay terminal.

In the fourth embodiment, the UE 30 requests the communication contract to the UE 40. When there is a plurality of UEs 40, the UE 30 requests the communication contract to the UE 40 that is most suitable for its own contract condition from the contract conditions of the UEs 40. At the time of execution of the contract, the communication contract fee is paid from (the user of) the UE 30 to the user of the UE 40. In addition to the payment to the NW provider, the communication contract fee may include a fee or the like for the node 11 that has performed authentication in the blockchain NW 10.

The UE 40 is a radio communication terminal that performs a wireless communication contract for relaying to the UE 30. The UE 40 provides wireless communication to the UE 30 according to the communication contract, and receives the communication contract fee from the UE 30. The UE 40 issues a request for a communication contract from the UE 30 as a transaction onto the blockchain NW 10 via the communication NW 50 before the contract. There may be a plurality of UEs 40.

The blockchain NW 10 verifies the signatures of the UE 30 and the UE 40 included in the transaction, and authenticates the transaction.

A communication procedure in the fourth embodiment illustrated in (1) to (4) of FIG. 15 is as described below.
(1) The UE 30 transmits, to the UE 40, a request for a communication contract to which its own signature is given.
(2) The UE 40 adds its own signature and issues a transaction onto the blockchain NW 10.
(3) The blockchain NW 10 verifies the signatures of the UE 40 and the UE 30, authenticates the transaction, and notifies the UE 40 of the authentication result.
(4) The UE 40 and the UE 30 execute the communication contract according to the transaction.

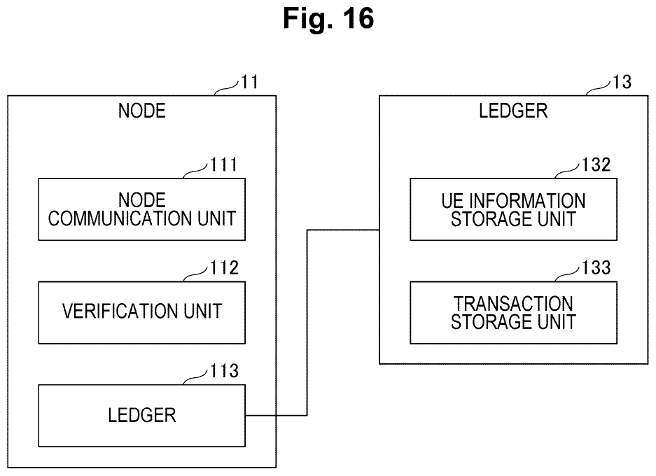

FIG. 16 is a diagram illustrating a functional configuration example of the node 11 of the blockchain NW 10 according to the fourth embodiment. In FIG. 16, the same parts as those in FIG. 3 are denoted by the same reference numerals, and the description thereof will be omitted as appropriate.

In FIG. 16, the ledger 113 does not include the BS information storage unit 131. This is because the BS 20 is not used in the fourth embodiment. However, the fourth embodiment and the first embodiment may be combined. In this case, the ledger 113 may include the BS information storage unit 131. The UE information storage unit 132 stores various types of information (public key or the like) of the UE 30 and the UE 40.

The node communication unit 111 exchanges blockchain information and transaction information with another node 11 and each UE 40.

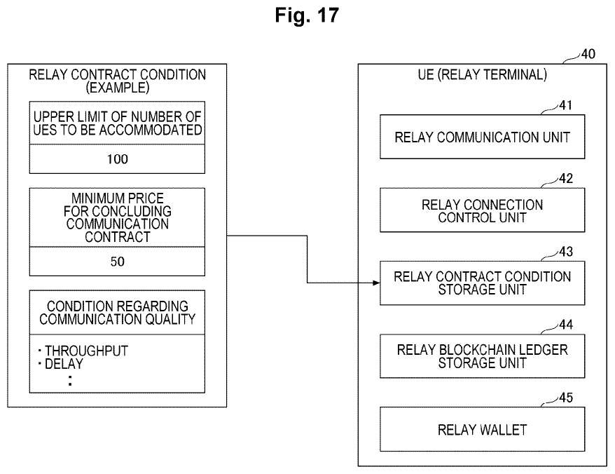

FIG. 17 is a diagram illustrating a functional configuration example of the UE 40 according to the fourth embodiment. The UE 40 functions as the BS 20 in the first embodiment. Accordingly, the UE 40 has a functional configuration similar to the functional configuration of the BS 20 illustrated in FIG. 4.

In FIG. 17, the UE 40 includes a relay communication unit 41 and a relay connection control unit 42. Each of these units is implemented by processing executed by the CPU of the UE 40 by one or more programs installed in the UE 40. The UE 40 also uses storage units such as a relay contract condition storage unit 43, a relay blockchain ledger storage unit 44, and a relay wallet 45. Each of these storage units can be implemented by using, for example, the auxiliary storage device of the relay or a storage device connectable to the relay via a network.

The relay communication unit 41 receives a request for a communication contract from a temporarily connected UE 30 and issues a transaction related to the communication contract onto the blockchain NW 10.

The relay connection control unit 42 specifies the UE 30 as a wireless communication provision destination on the basis of the communication contract related to the transaction approved on the blockchain NW 10, and provides the wireless communication to the UE 30.

The wireless communication standard used by the UE 40 for communication with the UE 30 may be any standard such as Wi-Fi (registered trademark) or Bluetooth (registered trademark), or may be limited by the contract condition (hereinafter referred to as “relay contract condition”) or the like of the UE 40.

The relay contract condition storage unit 43 stores the contract condition on the UE 40 side (hereinafter referred to as “relay contract condition”) in advance. The relay contract condition includes information similar to the BS contract condition in FIG. 4.

The relay blockchain ledger storage unit 44 stores transactions and the like approved on the blockchain NW 10.

The relay wallet 45 manages a secret key of the account of the UE 40. By using the relay wallet 45, the balance of the account can be confirmed, and the token can be taken in and out.

Note that the UE 40 may also have each function of the UE 30.

In the fourth embodiment, the functional configuration of the UE 30 may be similar to that in FIG. 5. However, for each function, the matters related to the BS 20 are replaced with the matters related to the UE 40.

In addition, the wireless communication standard used by the end communication unit 31 for communication with the relay communication unit 41 may be any standard such as Wi-Fi (registered trademark) or Bluetooth (registered trademark), or may be limited by the end contract condition or the like.

In addition, the UE 30 may also have each function of the UE 40.

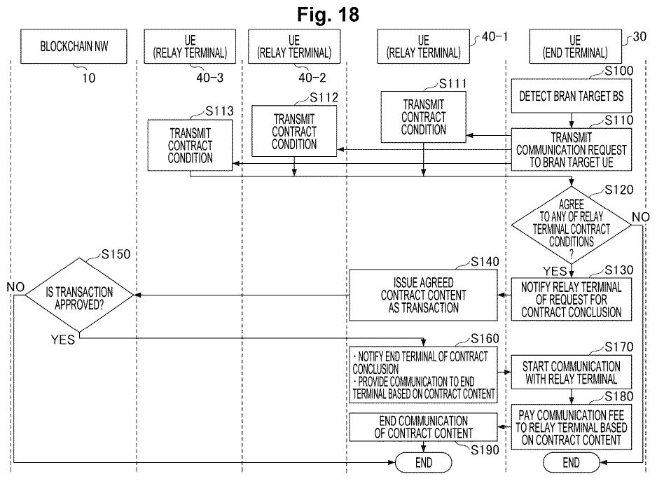

FIG. 18 is a diagram for describing an example of a processing procedure executed in the radio communication system according to the fourth embodiment. In FIG. 18, steps that are the same as or correspond to those in FIG. 6 are denoted by the same step numbers, and the description thereof will be omitted as appropriate.

As illustrated in FIG. 18, the processing procedure according to the fourth embodiment is different from the processing procedure according to the first embodiment in that the UE 40 executes the processing performed by the BS 20 in the first embodiment (FIG. 6). Note that the method of sensing a BRAN target UE in step S100 may be similar to the method of sensing the BRAN target BS in step S100 in FIG. 6.

As a result, the UE 30 can execute wireless communication via the UE 40.

As described above, according to the fourth embodiment, effects similar to those of the first embodiment can be obtained by replacing the BS 20 in the first embodiment with the UE 40.

Note that, in each of the above embodiments, the BS communication unit 21 or the relay communication unit 41 is an example of an issuance unit and a transmission unit.

The BS connection control unit 22 or the relay connection control unit 42 is an example of a provision unit. The end communication unit 31 is an example of a determination unit, a first communication unit, and a second communication unit. The connection destination decision unit 114 is an example of a decision unit.

Although the embodiments of the present invention have been described in detail above, the present invention is not limited to such specific embodiments, and various modifications/changes can be made within the scope of the gist of the present invention described in the claims.

### REFERENCE SIGNS LIST

10 Blockchain NW
11 Node
20 BS
21 BS communication unit
22 BS connection control unit
23 BS contract condition storage unit
24 BS blockchain ledger storage unit
25 BS wallet
30 UE
31 End communication unit
32 Payment processing unit
33 End contract condition storage unit
34 End wallet
40 UE
41 Relay communication unit
42 Relay connection control unit
43 Relay contract condition storage unit
44 Relay blockchain ledger storage unit
45 Relay wallet
50 Communication NW
100 Drive device
101 Recording medium
102 Auxiliary storage device
103 Memory device
104 CPU
105 Interface device
111 Node communication unit
112 Verification unit
113 Ledger
131 BS information storage unit
132 UE information storage unit
133 Transaction storage unit
114 Connection destination decision unit
B Bus

1. A radio communication system comprising:
one or more communication apparatuses that function as base stations for wireless communication, wherein
a communication apparatus of the one or more communication apparatuses includes
a first memory, and
a first processor coupled to the first memory and configured to
issue a transaction including information to a blockchain network by giving a signature of the communication apparatus to the information in response to receiving a request for contract conclusion of wireless communication from a radio communication terminal, the request including the information to which a signature of the radio communication terminal is given, and
provide the wireless communication to the radio communication terminal in a case where the transaction is approved based on verification of the signatures in the blockchain network.

2. The radio communication system according to claim 1, further comprising:
the radio communication terminal, wherein the first processor of the communication apparatus is configured to
transmit a contract condition to the radio communication terminal, and
the radio communication terminal includes
a second memory, and
a second processor coupled to the second memory and configured to
determine whether or not to transmit the request for the contract conclusion to the communication apparatus based on the contract condition.

3. The radio communication system according to claim 1, further comprising:
the blockchain network, wherein
the blockchain network includes
a third memory, and
a third processor coupled to the third memory and configured to
determine any one communication apparatus as a connection destination of the radio communication terminal from a list of the one or more communication apparatuses for which the radio communication terminal has detected radio waves, based on a contract condition of each of the one or more communication apparatuses and a contract condition of the radio communication terminal, the list being received from the communication apparatus regarding the transaction, and
the communication apparatus determined as the connection destination provides the wireless communication to the radio communication terminal.

4. The radio communication system according to claim 1, further comprising:
the blockchain network, wherein
the blockchain network includes
a third memory, and
a third processor coupled to the third memory and configured to
determine any one communication apparatus as a connection destination of the radio communication terminal from among the one or more communication apparatuses based on position information of the radio communication terminal, received from the communication apparatus regarding the transaction, and installation position information of each of the one or more communication apparatuses, and
the communication apparatus determined as the connection destination provides the wireless communication to the radio communication terminal.

5. The radio communication system according to claim 1, wherein
the communication apparatus is a radio communication terminal different from the radio communication terminal from which the request is received.

6. A communication apparatus that functions as a base station for wireless communication, the communication apparatus comprising:
a first memory; and
a first processor coupled to the first memory and configured to:
issue a transaction including information to a blockchain network by giving a signature of the communication apparatus to the information in response to receiving a request for contract conclusion of wireless communication from a radio communication terminal, the request including the information to which a signature of the radio communication terminal is given; and
provide the wireless communication to the radio communication terminal in a case where the transaction is approved based on verification of the signatures in the blockchain network.

7. A radio communication terminal comprising:
a second memory, and
a second processor coupled to the second memory and configured to:
transmit, to a communication apparatus functioning as a base station, a request for contract conclusion of wireless communication, the request including information to which a signature of the radio communication terminal is given; and
start the wireless communication using the communication apparatus in a case where a transaction in which a signature of the communication apparatus is given to the information is approved based on verification of the signatures in a blockchain network.

8. (canceled)

9. (canceled)

10. (canceled)

11. (canceled)

12. A non-transitory computer-readable recording medium having computer-readable instructions stored thereon, which when executed, cause a computer including a memory and a processor to function as the communication apparatus of claim 6.

13. A non-transitory computer-readable recording medium having computer-readable instructions stored thereon, which when executed, cause a computer including a memory and a processor to function as the radio communication terminal of claim 7.
